(19) United States
(12) Patent Application Publication
(10) Pub. No.: US 2026/0295901 A1
(43) Pub. Date: Oct. 1, 2026

(54) METHOD FOR SIMULTANEOUSLY SLICING A MULTIPLICITY OF SLICES FROM A WORKPIECE BY MEANS OF A WIRE SAW

(71) Applicant: SILTRONIC AG, Munich (DE)

(72) Inventors: Georg PIETSCH, Burghausen (DE); Alexander RIEGER, Kirchdorf (DE); Katharina WEINDL, Stubenberg (DE)

(21) Appl. No.: 18/880,280

(22) PCT Filed: Jun. 21, 2023
(86) PCT No.: PCT/EP2023/066805

§ 371 Date: Dec. 31, 2024

(30) Foreign Application Priority Data
Jul. 7, 2022 (EP) 22183659.6

(51) Int. Cl. B28D 5/00; B28D 5/04

(52) U.S. Cl. CPC B28D 5/0076; B28D 5/0088; B28D 5/045

(57) ABSTRACT

A method simultaneously slices slices from a workpiece by a wire saw. The method includes a slicing grinding process, where the workpiece is moved perpendicularly to a longitudinal axis of the workpiece towards a wire web of a sawing stretched between wire guide rollers. The sawing wire is moved longitudinally. A cooling lubricant is fed to the wire web. Slices that are fastened to a beam, with slicing gaps therebetween, are produced between sections of the wire web. The beam and the slices are removed from the wire web. The slicing gaps are sprayed with a fluid during removal of the beam and the slices until the wire sections have left the slicing gaps. The fluid is fed at high pressure through nozzles fastened to nozzle brackets moved in oscillating fashion parallel to the longitudinal axis. The fluid and entrained air occasionally stimulate vibration of the slices.

### CROSS REFERENCE TO RELATED APPLICATIONS

This application is a U.S. National Phase application under 35 U.S.C. § 371 of International Application No. PCT/EP 2023/066805, filed on Jun. 21, 2023, and claims benefit to European Patent Application No. EP 22183659.6, filed on Jul. 7, 2022. The International Application was published in German on Jan. 11, 2024 as WO 2024/008452 A1 under PCT Article 21 (2).

### FIELD

The present disclosure is directed to a method for simultaneously slicing a multiplicity of slices from a workpiece by means of a wire saw.

### BACKGROUND

Uniform slices with good plane-parallelism of their front and rear sides, which have few crystalline and structural defects, are required for a plurality of applications. One example is slices of a monocrystalline semiconductor material for the structuring of microelectronic components. Slices of this kind are obtained by cutting from a cylindrical workpiece, for example.

A method and a device for wire-sawing are disclosed in DE 10 2016 211 883 A1, for example. With wire sawing, sawing wire is guided spirally about at least two wire guide rollers, in such a manner that two wire guide rollers span a wire web facing the workpiece which is composed of wire sections extending parallel to one another. The lateral faces of the wire guide rollers are provided with a plurality of annularly closed grooves which extend in planes perpendicular to the axes of the wire guide rollers and which guide the sawing wire. Turning the wire guide rollers in the same direction produces a relative movement between the wire sections and the workpiece. A wire saw also has a feed device, to which the workpiece is fastened via a beam to which it is adhesively bonded, and which feeds the workpiece perpendicularly to the wire web. The relative movement and the presence of an abrasive cutting means result in a removal of material from the workpiece when contact is made between the workpiece and the wire web. With continued feed, the wire sections form slicing gaps in the workpiece and the wire web works slowly through the entire workpiece until the wire web comes to lie completely within the saw beam. The workpiece is then completely cut up into slices which hang from the beam like the teeth of a comb, held only by the adhesive joint.

Once the cutting process has ended, the workpiece, which has been cut up into slices, must be retrieved from the wire web by reversing the direction of movement of the feed device (ingot retrieval).

Wire sawing can be distinguished between wire slicing lapping and wire slicing grinding. In the case of wire slicing lapping, the sawing wire is free from abrasive agents to begin with, and the cutting means is supplied in the form of slurry as a freely movable grain dispersed in a carrier fluid. In the case of wire slicing grinding, abrasive cutting agents are anchored in the surface of the sawing wire and a cutting fluid is supplied, which acts as a cooling lubricant and does not contain any abrasive substances.

The sawing wire is usually composed of hypereutectoid pearlitic steel (piano wire). Straight (plain) sawing wires and structured (crimped) sawing wires are used.

In the case of wire slicing lapping, the cutting agent is usually composed of silicon carbide (SiC) and the carrier fluid usually of oil or glycol. In the case of wire slicing grinding, the cutting agent is usually composed of water, possibly with a wetting agent and anti-foaming additive, and the grinding agent anchored in the sawing wire is usually diamonds.

With wire sawing, the sawing wire is taken from a first stock, usually in the form of a first spool, onto which the sawing wire is wound, and fed to a second stock, usually likewise in the form of a second spool, following use. The first spool is referred to as the fresh wire spool and the second spool as the used wire spool. Wire sawing may involve unidirectional or bidirectional wire movement. In the case of unidirectional wire sawing, the sawing wire is moved in a longitudinal wire direction from the fresh wire spool to the used wire spool throughout the slicing process. In the case of wire sawing with bidirectional wire movement, the sawing wire is moved during the slicing process by means of at least one pair of reversals of direction, wherein a pair of reversals of direction comprises a first movement of the sawing wire in a first wire longitudinal direction by a first length and a second movement of the sawing wire in a second direction, which is exactly opposite to the first direction, by a second length. In particular, the wire sawing with bidirectional wire movement may comprise a plurality of pairs of wire reversals of direction of this kind, wherein the first length is chosen to be greater than the second length, so that the entire wire stock is moved during the slicing process from the fresh wire spool to the used wire spool. The aforementioned method is referred to as pilgrim mode slicing or wire-reciprocating slicing.

Wire saws can also be configured such that the workpiece can be pivoted about an axis parallel to the longitudinal axis of the workpiece during the slicing process. In particular, this rotational movement can be carried out in the form of a continuous sequence made up of a plurality of pairs of rotational changes, wherein a pair of a rotational change comprises a clockwise rotation at a first angular speed about a first angle, and a subsequent counter-clockwise rotation at a second angular speed about a second angle. In this case, first and second angular speeds and first and second angles may also vary during the course of the slicing process, for example depending on the cutting depth or depending on the instantaneous length of the sawing wire in the workpiece. This kind of recurrent swinging movement of the workpiece is also referred to as rocking of the workpiece. A device which is suitable for this purpose is described by US 2022/0134600 A1, for example.

During the slicing process, material is primarily removed along the contact surface, along which the sawing wire is in material-removing contact with the workpiece and which extends counter to the direction of the workpiece feed. This contact surface is referred to as the main cutting face. The contact surface, which takes in the sawing wire with the workpiece perpendicular to this direction, in other words in the direction of the workpiece axis, is referred to as the secondary cutting face, as no forces act here as a result of the workpiece feed and therefore no material is removed to begin with. The total of all instantaneous secondary cutting faces of a slicing gap over the entire slicing process create the front and rear sides of pairs of adjacent slices.

During wire sawing without rocking, the main cutting face extends along the entire arc length from the entry of the sawing wire into the slicing gap to the exit of the sawing wire from the slicing gap. During wire sawing with rocking, the main cutting face at any time is composed only of the short arc section, with which the sawing wire is in contact with the slicing line between the workpiece and the slicing gap, which slicing line is curved on account of the rocking. Rocking improves the supply of cooling lubricant or slurry to the slicing gap, even in the case of workpieces with large diameters.

With slicing lapping, the material removal rate is proportional to the pressure on the main cutting face. With slicing grinding, the material removal rate increases disproportionately with the pressure on the main cutting face. Slicing grinding (but not slicing lapping) can therefore be carried out more quickly with the help of the rocking than without rocking.

The removal of the workpiece which has been cut into slices from the wire web takes place after wire sawing by reversing the workpiece feed. In this case, the sawing wire is moved slowly in the wire longitudinal direction and cutting fluid is added, in order to draw cutting fluid as lubrication into the slicing gap and prevent friction of the sawing wire in the slicing gaps and a sticking of individual wire sections between the secondary cutting faces of a slicing gap lying opposite one other. With ingot retrieval after wire slicing lapping, most slurry drops off the sawing wire on account of the slow wire movement, before the sawing wire enters the slicing gap, so that the thickness of the slurry film which surrounds the sawing wire in the slicing gap is substantially smaller than the thickness of the slurry film during the preceding slicing process. There is therefore play on the sawing wire in the slicing gap during ingot retrieval following wire slicing lapping and it does not stick. This benefits a uniform sliding of the wire web through the slicing gap and finally out of said gap, without the sawing wire sticking between the secondary cutting faces of the gap or causing a removal of material from the secondary cutting faces.

In the case of wire slicing grinding, there is no cutting means slurry surrounding the sawing wire. The width of the slicing gap is therefore identical to the wire diameter, including the diamonds incorporated in the sawing wire. During ingot retrieval, there is therefore no play on the sawing wire within the slicing gap, meaning that it frequently sticks at different cutting depths. The slow wire longitudinal movement therefore means that an additional material removal takes place immediately and kerfs form in the walls of the slicing gap. Since the walls of a slicing gap form the front side of one slice and the rear side of the immediately adjacent slice, kerfs are thereby formed in the wafers which are obtained separately. Slices with kerfs in the surface are unsuitable for demanding applications.

While the sawing wire remains stuck at a cutting depth during ingot retrieval following wire slicing grinding, the feed device is reset further. The sawing wire is therefore deflected in the wire transverse direction and thereby stretched elastically in the wire longitudinal direction. The sawing wire thereby experiences an increasing restoring force. When this has grown sufficiently, the sawing wire jumps out of the cutting depth, at which it was stuck during retrieval, to a smaller cutting depth in which it sticks again, and so on (stick and slip movement of the sawing wire). If the tensile force exceeds the material strength of the sawing wire on account of the wire longitudinal extension due to the transverse deflection of the sawing wire, the sawing wire breaks during ingot retrieval. In this case, the workpiece must be completely removed from the defective wire web, the wire residues removed from the slicing gaps by hand, and the wire web repaired once again before the next slicing process. This is time-consuming and expensive.

The sawing wire occasionally breaks during the slicing process due to overloading or material defects in the sawing wire. The partially sliced workpiece then has to be removed from the defective wire web by resetting the feed device, the residual wire removed from the slicing gaps, the wire web repaired, the wire sections threaded back into the existing slicing gap, and the workpiece fed again up to the cutting depth at which the wire break occurred, so that the slicing process can be completed. In the case of wire slicing lapping, threading and feeding of the workpiece in the wire web occur effortlessly and without the sawing wire getting caught at given cutting depths, since the sawing wire has sufficient play in the slicing gap on account of the surrounding slurry film. In the case of wire slicing grinding, in which the sawing wire has no freedom of movement, the sawing wire sticks during the feeding of the workpiece and kerfs are produced.

Even if the diamond-coated sawing wire catches in an unforeseeable manner during the feed of the workpiece after the wire has broken or when the feed is being reset from the wire web during an ingot retrieval, the lack of freedom of movement nevertheless leads in each case to an additional removal of material from the side walls delimiting the gap and therefore to damage of the front and rear sides of the slices concerned. This kind of damage causes material stress in the damaged surface which, when stresses on the front side of the slice and on the rear side of the slice do not balance one another (which is not usually the case), cause elastic deformation to the slice. This elastic deformation due to surface damage is superimposed on the plastic deformation, and the plastic deformation cannot be determined in isolation by determining the slice shape by measuring after the wire sawing, and therefore cannot be selectively removed by suitable measures either. The latter is necessary since the elastic deformation disappears when the damaged layers are removed in the subsequent material-removing processing, while the plastic deformation remains if it is not removed by selective material removal.

US 2009/0223539 A1 describes a method for cleaning wafers for solar applications, for example, said wafers being immersed in a cleaning bath upon completion of the slicing process and removal from the wire saw, still hanging from the saw beam (sacrificial beam) by their adhesive joint. The slicing gaps (kerfs) are exposed to rinsing fluid from multiple separate spray nozzles. At the point where rinsing fluid is sprayed in, the slicing gap widens in the water bath, so that the cleaning action is increased. By moving the nozzles relative to the workpiece, all slicing gaps can be widened one after the other and thereby successively cleaned. The method described makes no contribution to avoidance of the consequences of a stick-and-slip movement of the sawing wire during ingot retrieval.

JP 2006-66793 A describes a similar method in which a block of cut-up slices is sprayed with a spray fluid upon completion of the slicing process and removal from the wire saw, for the purpose of cleaning the sides by means of spray nozzles.

US 2011/0168212 describes a similar method for cleaning thin, easily breakable solar wafers following sawing and removal of the sliced workpiece from the wire saw.

JP2004-106360 describes a method in which, following wire slicing lapping and ingot retrieval of a workpiece, a rinsing fluid is sent through channels present in the beam to clean the slicing gaps.

### SUMMARY

In an embodiment, the present disclosure provides a method that simultaneously slices a plurality of slices from a workpiece by a wire saw. The method includes: executing a slicing grinding process, where the workpiece is moved perpendicularly to a longitudinal axis of the workpiece towards a wire web of a sawing wire of the wire saw stretched between two wire guide rollers, where the sawing wire is moved in the longitudinal direction of the sawing wire, where a cooling lubricant is fed to the wire web, and where slices which are fastened to a beam, and between which slicing gaps exist, are produced between wire sections of the wire web; removing the beam and the slices from the wire web; and spraying the slicing gaps with a fluid by a sprayer, during removal of the beam and the slices, until the wire sections have left the slicing gaps. The fluid is fed at high pressure through nozzles fastened to nozzle brackets, which are moved in oscillating fashion parallel to the longitudinal axis of the workpiece. The fluid and entrained air occasionally stimulate vibration of the slices.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows features of a wire saw and of a workpiece which contribute to understanding of the present disclosure; and

FIG. 2 (A) and 2 (B) show details of a spray device which is suitable for carrying out the method according to the present disclosure.

### DETAILED DESCRIPTION

Aspects of the present disclosure avoid stick-and-slip movements of the sawing wire and the disadvantageous consequences thereof.

Aspects of the present disclosure provide a method for the simultaneous cutting of a plurality of slices from a workpiece by means of a wire saw. The method includes:
a slicing grinding process, wherein a workpiece is moved perpendicularly to a longitudinal axis of the workpiece towards a wire web of a sawing wire stretched between two wire guide rollers, which sawing wire is moved in the longitudinal direction of the sawing wire, wherein a cooling lubricant is fed to the wire web, and wherein slices which are fastened to a beam, and between which slicing gaps exist, are produced between wire sections of the wire web, and
the removal of the beam and the slices from the wire web;
the spraying of the slicing gaps with a fluid by means of a spray device during removal of the beam and the slices, until the wire sections have left the slicing gaps, wherein the fluid is fed at high pressure through nozzles fastened to nozzle brackets which are moved in oscillating fashion parallel to the longitudinal axis of the workpiece, wherein the fluid and the entrained air occasionally stimulate vibration of the slices.

During the removal, the nozzles spray fluid onto the slicing gaps. The surrounding air is swirled during this and the slices are caused to vibrate by means of the Bernoulli effect. The nozzle brackets perform an oscillating stroke movement parallel to the workpiece axis, which is why fluid from at least one nozzle in the plane of the corresponding slicing gap occasionally encounters each slicing gap. In this way, fluid gets deep into the slicing gaps and the change in spraying pressure caused by the oscillating movement gradually brings about a continuous periodic fanning of all slicing gaps during the removal of the strip and the slices from the slicing gaps.

The pressure at which the fluid is fed through the nozzles is preferably selected in such a manner that the exit speed of the rinsing agent corresponds to the speed at which the wire is moved relative to the workpiece.

The nozzles are preferably a constituent part of a spray device comprising at least one nozzle bracket in each case, which are arranged to the side of the wire guide rollers of the wire web between the respective wire guide roller and the workpiece. The nozzle brackets can execute a stroke movement parallel to the workpiece axis and are preferably arranged parallel to the rotational axes of the wire guide rollers.

Particularly preferable are precisely two nozzle brackets, in respect of which, viewed in the direction of the workpiece axis, a fresh wire is arranged at the entry side and a used wire at the exit side of the workpiece. The nozzles are preferably oriented in such a manner that each nozzle produces a partial flow of fluid which is oriented tangentially to the wire web and in one of the planes in which the slicing gaps extend. The amplitude of the oscillating movement, at which the respective nozzle bracket is moved parallel to the longitudinal axis of the workpiece, is preferably at least half the space between two adjacent nozzles. The total stroke corresponding to the double amplitude is therefore at least the space between two nozzles. In this way, it is guaranteed that following a period of oscillating movement, each nozzle has covered all slicing gaps which are situated between this nozzle and the adjacent nozzle.

The number of nozzles per nozzle bracket is preferably 10 to 50. The highest number of nozzles possible is particularly preferred. The upward limit of the number is only determined by the dimensions of the nozzles. The required stroke of the oscillation movement of the nozzle bracket is therefore smaller and the coverage of the slicing gaps takes place at shorter intervals.

During the slicing grinding process, the workpiece is fed by means of a feeding device. The wire guide rollers turn in the same direction, so that the wire sections describe a relative movement to the workpiece and during engagement with the workpiece as a consequence of the feed movement, a material removal takes place.

At the end of the slicing grinding process, the workpiece is completely sliced up and a plurality of slicing gaps running parallel to one another between slices is created, the slices being held by the beam.

The removal of the beam and the slices from the slicing gaps includes the resetting of the feed device while the wire sections move in the wire longitudinal direction in the presence of cooling lubricant.

The workpiece is preferably a cylindrical rod composed of monocrystalline semiconductor material.

The method preferably also comprises the pivoting of the workpiece about an axis parallel to the longitudinal axis of the workpiece during the slicing grinding process, wherein the workpiece performs a plurality of pairs of pivoting movements, and a pair of pivoting movements comprises a first pivot about a first angle at a first angular speed and a following second pivot about a second angle at a second angular speed. The first and second angular speeds and the first and second angles of two pairs of successive pairs of pivoting movements are preferably different.

The sawing wire is preferably hypereutectoid pearlitic steel wire (piano wire) with cutting means fixed to the surface thereof. The cutting means are preferably diamonds.

The movement of the sawing wire in the longitudinal direction during the slicing grinding process can take place with or without a reversal of direction. During the movement of the sawing wire in the longitudinal direction with a reversal of direction, the sawing wire is moved by means of a plurality of pilger steps, wherein each pilger step comprises a first movement of the wire in a first longitudinal direction about a first length and a second movement of the sawing wire in a second longitudinal direction exactly opposite the first wire longitudinal direction about a second length, and the first length is greater than the second length.

The cooling lubricant and the fluid are preferably made of water which contains a liquid additive where necessary. They may both have an identical or distinct composition. The liquid additive is preferably a wetting agent, a corrosion inhibitor, a viscosity-modifying agent, for example glycol and/or methyl cellulose, a defoaming agent or any mixture of these agents.

The procedure according to an aspect of the present disclosure is preferably also used to react appropriately to an interruption in the slicing grinding process, in particular as a result of a breaking of the sawing wire. It prevents wire sections from sticking and grooves or elastic deformations from adversely affecting the quality of the slices during removal of the workpiece after the wire has broken and during the reverse movement of the workpiece back into the position prior to the breaking of the wire.

The interruption of the slicing grinding process takes place while movement of the sawing wire in the longitudinal direction continues and comprises the removal of the workpiece from the slicing gaps, the return of the workpiece into the slicing gaps, and the continuation of the slicing grinding process. During the return of the workpiece, fluid is sprayed through the nozzles into the slicing gaps and the nozzle brackets are moved parallel to the longitudinal axis of the workpiece.

The movement of the sawing wire in the longitudinal direction during the slicing grinding process preferably takes place at a speed which is at least ten times faster than the speed of the movement of the sawing wire in the longitudinal direction during the removal and return of the workpiece when the slicing grinding process is interrupted.

Aspects of the present disclosure are presented below with reference to drawings in a preferred exemplary embodiment of a wire saw.

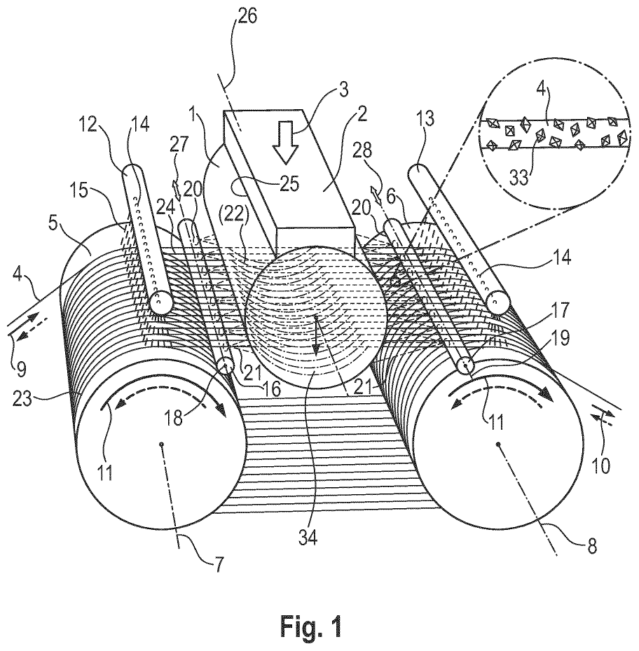

As shown in FIG. 1, during wire sawing, the sawing wire 4 is guided spirally about at least two wire guide rollers, in such a manner that two wire guide rollers 5 and 6 span a wire web 24 facing the workpiece 1, which is composed of wire sections running parallel to one another. The wire guide rollers exhibit the shape of straight circular cylinders with rotational axes 7 and 8, which are oriented parallel to one another and about which they can be turned in directions 11. The lateral faces of the wire guide rollers are provided with a plurality of annularly closed grooves 23, which extend in planes which are perpendicular to the rotational axes 7 and 8, which grooves guide the sawing wire 4. Turning the wire guide rollers in the same direction produces a relative movement between the wire sections and the workpiece. In this case, fresh sawing wire is taken from a first wire stock, the so-called fresh wire spool, (direction 9) and used sawing wire is fed to a second wire stock, the so-called used wire spool (direction 10). The wire saw also has a feed device, to which the workpiece 1 is fastened by an adhesive joint 25 with a beam 2 and which feeds the workpiece perpendicularly to the wire web (direction 3). The relative movement and the presence of an abrasive cutting means produce a removal of material from the workpiece upon contact between the workpiece and wire web. Through the continued feed, relative movement and supply of cutting means, each wire section of the wire web 24 forms a slicing gap 22 by means of continued material removal from the workpiece. The side walls of a slicing gap 22 each delimit the rear side of one and the front side of a second slice 34 of a pair of immediately adjacent wafers.

The cutting means (cutting material) are diamonds 33 which are fixedly incorporated in the surface of the wire 1. During the slicing grinding process, a cooling lubricant 15 is fed to the wire web 24 via two nozzle brackets 12, 13 to the left and right of the workpiece, which are provided with nozzles 14, the cooling lubricant itself contains no abrasive cutting means (hard substances). The slicing grinding process ends when the entire wire web has completely worked through the workpiece and comes to rest in the beam 2. The slices 34 of the completely cut-up workpiece then hang like teeth of a comb from the half sliced-through beam, only connected to the beam 2 by the adhesive joint 25.

The wire saw which is shown is provided with a left nozzle bracket 16 and a right nozzle bracket 17. The nozzle brackets 16, 17 carry a plurality of nozzles 20 which spray a fluid 21 onto the slicing gap 22 in the workpiece 1. The axes 18 and 19 of the nozzle brackets are arranged parallel to one another and parallel to the rotational axes 7 and 8 of the wire guiding rollers 5 and 6 stretching the wire web 24 and perpendicularly to the slicing gaps 22 of the workpiece 1 or parallel to the longitudinal axis 26 of the workpiece 1. The nozzle brackets perform oscillating movements 27 and 28 in directions of their axes 18 and 19. Through this periodic displacement, the flows of fluid 21 which leave the individual nozzles 20 cover the slicing gaps 22 of the workpiece 1 at periodic intervals.

The preferred arrangement according to FIG. 1 shows the nozzle bracket 16 to the left of the workpiece 1, in other words on the fresh wire entry side, and the nozzle bracket 17 to the right of the workpiece 1, in other words on the used wire exit side, and both below the wire web 24, viewed from the direction of the feed device. Deviating from this, the nozzle brackets may also be arranged above the wire web 24.

The method according to an aspect of the present disclosure may also be carried out using a wire saw, in which the workpiece can be pivoted during the slicing grinding process about an axis parallel to the longitudinal axis of the workpiece. During this rocking, only a partial section of the entire wire section running within a slicing gap comes into material-removing contact with the workpiece at any point in time. Viewed in the wire longitudinal direction, gaps are formed before and after this momentary contact face between the sawing wire and the workpiece extending in the direction of the workpiece feed. If the nozzle brackets are arranged above the wire web, the fluid can get between the sawing wire and workpiece particularly well. If the nozzle brackets are arranged below the wire web, virtually no fluid can get between the sawing wire and workpiece, despite the rocking. On the other hand, in this case the cut-up parts of the workpiece-the subsequent wafers-projecting below the wire web are caused to vibrate particularly effectively by the Bernoulli effect of the flow of fluid and periodic enlargement and reduction in the slicing gap width is thereby caused.

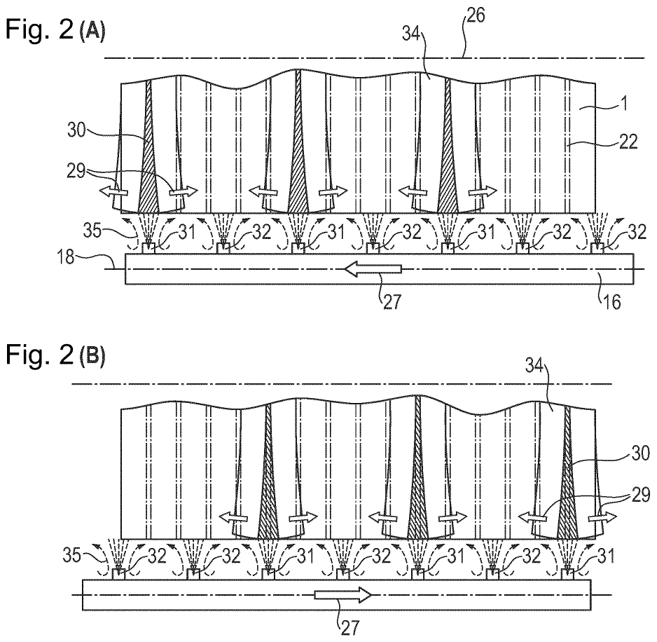

FIGS. 2(A) and (B) shows details of a spray device (sprayer) comprising the nozzle brackets 16 and 17 in plan view (viewed from the direction of the feed device) on the left nozzle bracket 16 and a part of the workpiece 1 with the slicing gaps 22 and the longitudinal axis 26 of the workpiece.

FIG. 2(A) shows the nozzle bracket 16 with axis 18 parallel to the longitudinal axis 26 of the workpiece at the start of the oscillating movement 27 parallel to the axis 18. There are nozzles 31, part of the flow of fluid 21 from which runs precisely in the plane of a slicing gap 22 in each case, as a result of which fluid 21 is forced deep into the slicing gap 22. During this process, the pair of adjacent slices 34 which the slicing gap 22 divides is pressed away from the slicing gap elastically in movement directions 29, as a result of which the slicing gap is widened elastically into a widened slicing gap 30. Moreover, there are nozzles 32, from which none of the flow of fluid 21 flows within the plane of a slicing gap 22, and which do not therefore widen a slicing gap elastically. The flows of fluid 21 entrain air 35 from the environment by means of momentum exchange.

When the left nozzle bracket 16 has performed the oscillating movement 27 in the direction of the axis 18, it reaches the position shown in FIG. 2(B) of the other end of its oscillating movement. The nozzles 31, some of the flows from which press fluid into a slicing gap and thereby widen it, are in a different position and widen other slicing gaps to those in the arrangement according to FIG. 2(A). The amplitude of the oscillating movement 27 amounts at least to the value of the space between two adjacent nozzles.

During the oscillating movement 27, the flows of fluid 21 (fluid incompressible) and the air 35 entrained by the flows (air/gas compressible) spread beyond slices 34 and slicing gaps 22. Since they flow around slices and slicing gaps in different planes during the oscillating movement, the slices 34 are stimulated by the dynamic air pressure changes of the air entrained by the flows to produce vibrations (Bernoulli effect). In other words, elastic deflections of the slices and periodically widening and tapering slicing gaps are caused.

The investigations on which the present disclosure is based, aimed at avoiding the stick-and-slip of the sawing wire during ingot retrieval and during repositioning of a workpiece following an interruption of the slicing grinding process, have shown that a stimulation of vibrations in the slices is necessary, in order to reduce the frictional forces of the sawing wire in the narrow slicing gap. A widening of the slicing gap by forcibly pressing in fluid at changing slicing gaps, and the cleaning effect associated with this as the single measure, takes place too slowly. It is therefore not possible to prevent the sawing wire from producing grooves or strain-induced warpage during ingot removal or during the repositioning of the workpiece following an interruption.

Only the stimulation of vibrations in the slices by means of the Bernoulli effect through a flow of fluid and entrained air has proved a suitable means of achieving the object.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS USED

1 workpiece
2 beam
3 feed direction
4 sawing wire
5 left wire guide roller
6 right wire guide roller
7 rotational axis
8 rotational axis
9 direction of the wire supply
10 direction of the wire removal
11 direction of rotation of the wire guide roller
12 bracket
13 bracket
14 nozzle
15 cooling lubricant
16 left nozzle bracket
17 right nozzle bracket
18 axis of the left nozzle bracket
19 axis of the right nozzle bracket
20 nozzle
21 fluid
22 slicing gap
23 groove
24 wire web
25 adhesive joint
26 longitudinal axis of the workpiece
27 oscillating movement
28 oscillating movement
29 movement direction
30 widened slicing gap
31 nozzle
32 nozzle
33 diamonds
34 slice
35 entrained air

1. A method for simultaneously slicing a plurality of slices from a workpiece by a wire saw, the method comprising:
executing a slicing grinding process, wherein a the workpiece is moved perpendicularly to a longitudinal axis of the workpiece towards a wire web of a sawing wire of the wire saw stretched between two wire guide rollers, wherein the sawing wire is moved in the longitudinal direction of the sawing wire, wherein a cooling lubricant is fed to the wire web, and wherein slices which are fastened to a beam, and between which slicing gaps exist, are produced between wire sections of the wire web, and;
removing the beam and the slices from the wire web; and
spraying the slicing gaps with a fluid by a sprayer, during removal of the beam and the slices, until the wire sections have left the slicing gaps, wherein the fluid is fed at high pressure through nozzles fastened to nozzle brackets. which are moved in oscillating fashion parallel to the longitudinal axis of the workpiece, wherein the fluid and entrained air occasionally stimulate vibration of the slices.

2. The method as claimed in claim 1, wherein an amplitude of the oscillating movement is equal to, or greater than, a total space between two adjacent nozzles of the nozzles.

3. The method as claimed in claim 1, the method further comprising interrupting the slicing grinding process while movement of the sawing wire in the longitudinal direction continues, which comprises:
removing the workpiece from the slicing gaps;
returning the workpiece into the slicing gaps; and
then continuing the slicing grinding process, wherein during the return of the workpiece, fluid is sprayed through the nozzles into the slicing gaps and the nozzle brackets are moved parallel to the longitudinal axis of the workpiece.

4. The method as claimed in claim 1, the method further comprising pivoting the workpiece about an axis parallel to the longitudinal axis of the workpiece during the slicing grinding process, wherein the workpiece performs a plurality of pairs of pivoting movements, and a pair of pivoting movements comprises a first pivot about a first angle at a first angular speed and a following second pivot about a second angle at a second angular speed.

5. The method as claimed in claim 4, wherein the first angular speed and the second angular speeds and the first angle and the second angle of two pairs of successive pairs of pivoting movements are different.

6. The method as claimed in claim 1, wherein the cooling lubricant comprises water and a first liquid additive and the fluid comprises water and a second liquid additive.

7. The method as claimed in claim 6, wherein the first liquid additive and the second liquid additive are identical and comprise a wetting agent or a corrosion inhibitor or a viscosity-influencing agent, a defoaming agent or mixture of these.

8. The method as claimed in claim 1, wherein the sawing wire comprises hypereutectoid pearlitic steel wire with diamonds fixed to the surface for cutting.

9. The method as claimed in claim 1, wherein the workpiece is a cylindrical rod of monocrystalline semiconductor material.

10. The method as claimed in claim 3, comprising the movement of the sawing wire in the longitudinal direction during the slicing grinding process at a speed which is at least ten times faster than the speed of the movement of the sawing wire in the longitudinal direction during the removal and return of the workpiece.

11. The method as claimed in claim 1, comprising the movement of the sawing wire in the longitudinal direction without a reversal of direction.

12. The method as claimed in claim 1, comprising the movement of the sawing wire in the longitudinal direction with a reversal of direction, wherein the sawing wire is moved by a plurality of pilger steps, each pilger step comprising a first movement of the wire in a first longitudinal direction about a first length and a second movement of the sawing wire in a second longitudinal direction exactly opposite the first wire longitudinal direction about a second length, and the first length is greater than the second length.
